(19) United States
(12) Patent Application Publication
(10) Pub. No.: US 2003/0212832 A1
(43) Pub. Date: Nov. 13, 2003

(54) Additional software loading terminal device, additional software loading method and program therefor

(75) Inventors: Atsuko Takahashi, Tokyo (JP); Tetsuji Seta, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/424,842

(22) Filed: Apr. 29, 2003

(30) Foreign Application Priority Data
May 10, 2002 (JP) 2002-135828

(51) Int. Cl. G06F 15/163; G06F 9/54; G06F 9/00

(52) U.S. Cl. 709/310

(57) ABSTRACT

A terminal device, which is activated by a connection across a network to a main apparatus that controls a terminal, comprises first conventional software application for controlling a terminal resource, a first CPU for executing the first software application, a second software application for executing a new application that is added, and a second CPU for executing the second software application,

wherein the second software application includes data relay means for switching paths for the exchange of data by the first software application, the main apparatus and the new application, and

wherein the new application controls the data relay means for switching between a conventional terminal mode and an application occupation mode.

### BACKGROUND OF THE INVENTION

1. Field of the Invention

The present invention relates to a terminal device in which additional software is loaded to accompany the addition of a terminal software function, and an additional software loading method and a program therefor.

2. Description of the Related Art

Conventional terminal software is available that interacts with a main apparatus, such as a switchboard system, to provide services for a conventional terminal in which a low-performance CPU is mounted. There is also a case wherein, in order to add a new function, a service is provided for a terminal employing a high-performance CPU by loading an application that permits the terminal to handle part of the terminal control data, such as the display data for a terminal display device, that conventionally are generated by the main apparatus. In this case, the function of the terminal software that is executed by a low-performance CPU may be incorporated in an application executed by a high-performance CPU to create the new application.

Conventionally, since in this case a function is added by changing all conventional terminal software in order to prepare a new application that can be used to provide a new function, a very large number of steps are required for the development of the software.

### SUMMARY OF THE INVENTION

An object of the present invention is to provide a terminal device in which an additional software application is provided for loading a new application that has been developed, using fewer steps, by employing a software application for a conventional terminal, and an additional software loading method and a program therefor.

To this end, a additional software loading terminal device includes

a first computer program for controlling a terminal resource;

a first CPU for executing said first software application;

a second computer program for executing a new application; and

a second CPU for executing said second software application,

wherein said second software includes a data relay unit for switching paths for an exchange of data among said first software application, said main apparatus and said new application, and

wherein said new application controls said data relay unit for switching between a conventional terminal mode and an application occupation mode.

Advantageously, since a new application can be mounted by directly using the functions provided by conventional terminal software, an additional service can be provided merely by developing a difference between the original and new services. That is, functions provided by conventional software can be fetched without having to be regenerated and rebuilt into the new application, and the terminal control is enabled. Therefore, the number of required development procedures can be reduced, compared with when a new application is developed by installing the conventional terminal software.

### BRIEF DESCRIPTION OF THE DRAWINGS

The above and other objects, features and advantages of the present invention will become more apparent from the following detailed description when taken in conjunction with the accompanying drawings wherein:

FIG. 1 is a system block diagram showing data transmissions in an application occupation mode and a conventional terminal mode;

FIG. 2 is a system block diagram showing one embodiment in the conventional terminal mode;

FIG. 3 is a system block diagram showing another embodiment (example of the relay of conventional software data) in the application occupation mode;

FIG. 4 is a system block diagram showing an additional embodiment (a pseudo data transmission example) in the application occupation mode; and

FIG. 5 is a system block diagram showing a further embodiment for switching from the application occupation mode to the conventional terminal mode.

### DETAILED DESCRIPTION OF THE PREFERRED EMBODIMENT

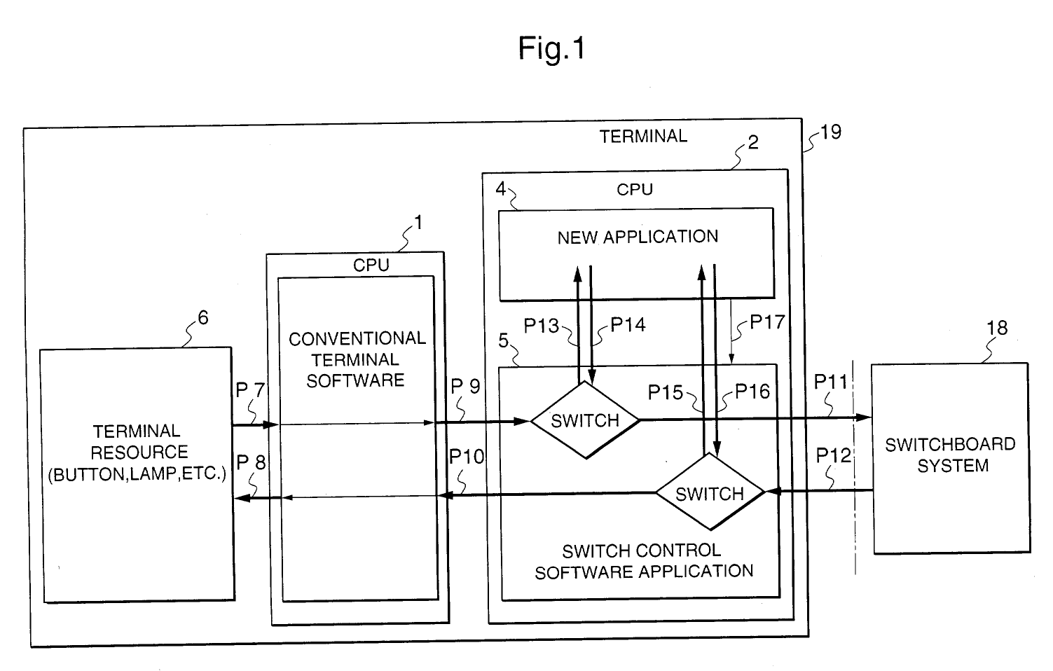

Additional Software Loading Terminal Device embodying the present invention will be described with reference to FIG. 1 through FIG. 5.

The configuration will now be described while referring to FIG. 1. FIG. 1 is a system block showing a terminal device 19 for which, in accordance with the embodiment of the present invention, additional software is loaded, and a switchboard system 18. The terminal 19 can be applied for a portable telephone, a small personal computer (PC), a personal data assistant (PDA), a personal handyphone system (PHS) and soon, and the switching system 18 can be a data processing apparatus, such as a server, while the terminal 19 and the switching board system 18 can be connected through a network, such as the Internet.

The software for the terminal 19 includes conventional terminal software application 3 for controlling a terminal resource 6 operated by a low-performance CPU 1, a new application 4, executed by a high-performance CPU 2, and a switch control software application executed by the application 4.

The switch control software application 5, together with the new application 4, is executed by the high-performance CPU 2 and relays terminal status related data, which are transmitted by the conventional terminal software application 3 executed by the low-performance CPU 1 mounted on the conventional terminal, and terminal control data, which is transmitted by the switchboard system 18 to the conventional terminal software application 3.

Under the control of the application 4, the switch control software application 5 controls the directions in which data is exchanged by the low-performance CPU 1 (conventional terminal software application 3), the application 4 and the switchboard system 18. The application 4 includes an interface for controlling the switch control software 5.

The CPU 1 where the conventional software application 3 is loaded is a CPU having a comparatively high performance, and the new application 4 and the switch control software application 5 maybe loaded for the same CPU 1. Further, the portion constituted by the application 4 can be replaced independent of the switch control software application 5.

An operation performed by the embodiment of this invention will now be described with reference to FIG. 1. The new application 4 employs the switch control software control data 17 to set the operating mode for the switch control software application 5. The operating modes are an application occupation mode in which the terminal 19 is controlled by the application 4, and a conventional terminal mode for executing unchanged a service provided by the conventional terminal software application 3.

First, the operation performed when the application occupation mode is set will be described. This explanation will be given by using, as an example, the transmission of button depression data, which occurs when the button at the terminal resource 6 is depressed for ascending data 7 to be transmitted by the terminal 19. When the button depression detection function is implemented by the conventional terminal software application 3, button depression data 7 is converted into the data 9 form for transmission to the switchboard system 18, and the data 9 are transmitted to the switch control software 5. Upon receiving the data 9, the switch control software application 5 transmits button depression data 13 only to the new application 4, and does not transmit data 11 to the switchboard system 18.

Further, even when the button has not actually been depressed, in the application occupation mode, the new application 4 generates pseudo button depression data 14, as needed, and transmits the pseudo button depression data 14 to the switch control software application 5. Thus, the pseudo button depression data 14 can be transmitted as the button depression data 11 to the switchboard system 18.

An explanation will now be given for an example in which the transmission of data is performed for a case wherein lamp ON data, received as descending command data, are transmitted by the switchboard system 18 when the application occupation mode is set. The lamp ON data 12 is transmitted by the switchboard system 18 to the switch control software application 5. The switch control software application 5, however, does not transmit data 10 to the conventional terminal software application 3.

Further, when in the application occupation mode the application 4 turns on the lamp of the terminal, the application 4 transmits pseudo lamp ON data 16 to the switch control software application 5, as needed, so that the lamp ON data 10 is issued to the conventional terminal software application 3. Subsequently, to turn on the lamp, the conventional terminal software application 3 analyzes the lamp ON data 10 and issues an I/O order 8 for the lamp to be switched on.

As is described above, when the application occupation mode in this embodiment has been set, the new application 4 occupies the terminal resource 6 of the terminal 19. That is, all the ascending data, such as the button depression data, can be used only by the application 4. Furthermore, only the contents instructed by the application 4 can be represented by using the lamp or the LCD (Liquid Crystal Display).

The operation performed in the conventional terminal mode will now be described. An explanation will be given by using, as an example, the transmission of button depression data when the button of the terminal resource 6 is depressed for the ascending data 7 to be transmitted by the terminal 19. By employing the button depression detection function implemented by the conventional terminal software 3, the button depression data 7 is converted and assumes the form of the data 9 for transmission to the switchboard system 18, while the data 9 is transmitted to the switch control software application 5. The switch control software application 5, as well as the conventional terminal, retransmits the data 9 as button depression data 11 to the switchboard system 18. In addition, the switch control software application 5 transmits button depression data 13 to the new application 4 in a case wherein, through button depression, the new application 4 controls the terminal status.

An explanation will now be given, using a data transmission example, for a case wherein the lamp ON data is received for the descending data 12, transmitted by the switchboard system 18, when the conventional terminal mode is set. The lamp ON data 12 is transmitted by the switchboard system 18 to the switch control software 5, and is transmitted unchanged, as data 10, to the conventional terminal software application 3, as well as to the conventional terminal. Then, to turn on the lamp, the conventional terminal software 3 analyzes the data 10 and issues the I/O order 8 to switch on the lamp. Furthermore, lamp ON data 15 is also transmitted to the new application 4 in a case wherein the new application 4 displays the terminal status.

As is described above, in the conventional terminal mode of this invention, the conventional terminal software application 3 is executed unchanged, and all the ascending data, such as the button depression data, are transmitted to the switchboard system 18. In addition, a display for which the lamp or the LCD is employed is performed as instructed by the switchboard system 18.

An explanation will now be given for specific examples for the terminal 19 wherein multiple new applications are mounted, and wherein the application occupation mode and the conventional terminal mode are fixed for individual applications, and are designated by switching between the applications. Since the application 4 can designate the application occupation mode and the conventional terminal mode, the application 4 can determine the mode in which data is transmitted from the switch control software 5 to the application 4.

In this embodiment, to simplify the configuration of the application 4, the switch control software 4 has a two-layer structure and includes two added portions, one for buffering the data received from the switchboard 18 and the other for buffering data to be transmitted to the application 4. The application 4 refers to these buffers.

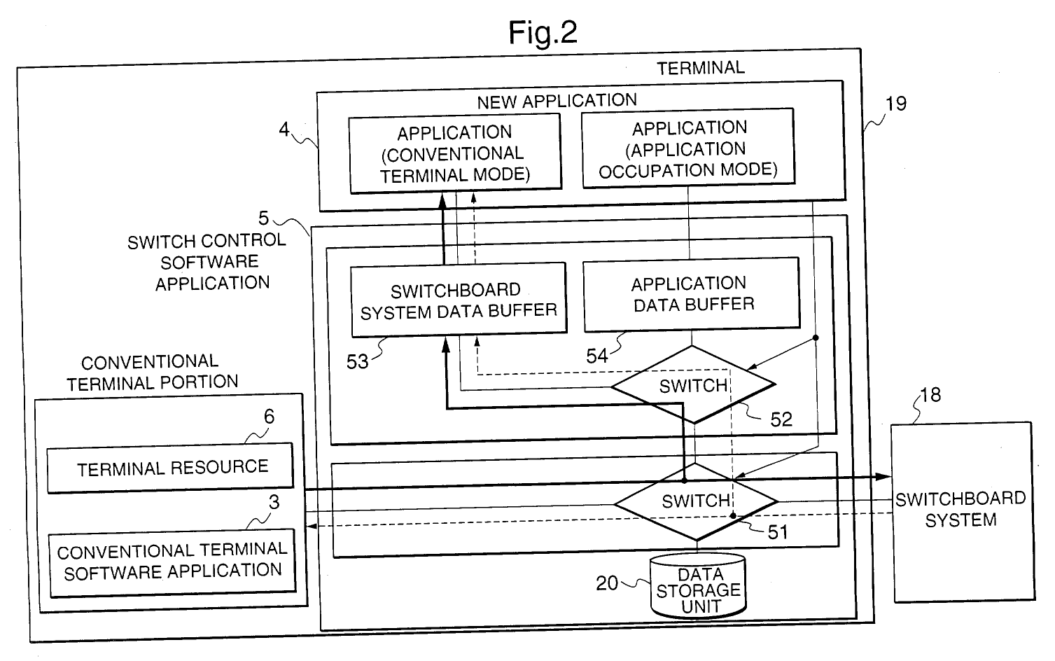

In FIG. 2 is shown another embodiment operated in the conventional terminal mode. In FIG. 2, arrows indicated by solid lines represent data forwarded in the ascending direction, and arrows indicated by broken lines represent data forwarded in the descending direction. When the conventional terminal resource 6 detects data, such as button depression data, the detection message is transmitted through a switch 51 to the switchboard 18. This message is also transmitted to the application 4 through switches 51 and 52 and a switchboard system buffer 53. And when data, such as lamp ON data, is received from the switchboard system 18, this data is transmitted to the conventional terminal software application 3 through the switch 51. This data is also transmitted to the application 4 through the switches 51 and 52 and the switchboard system buffer 53.

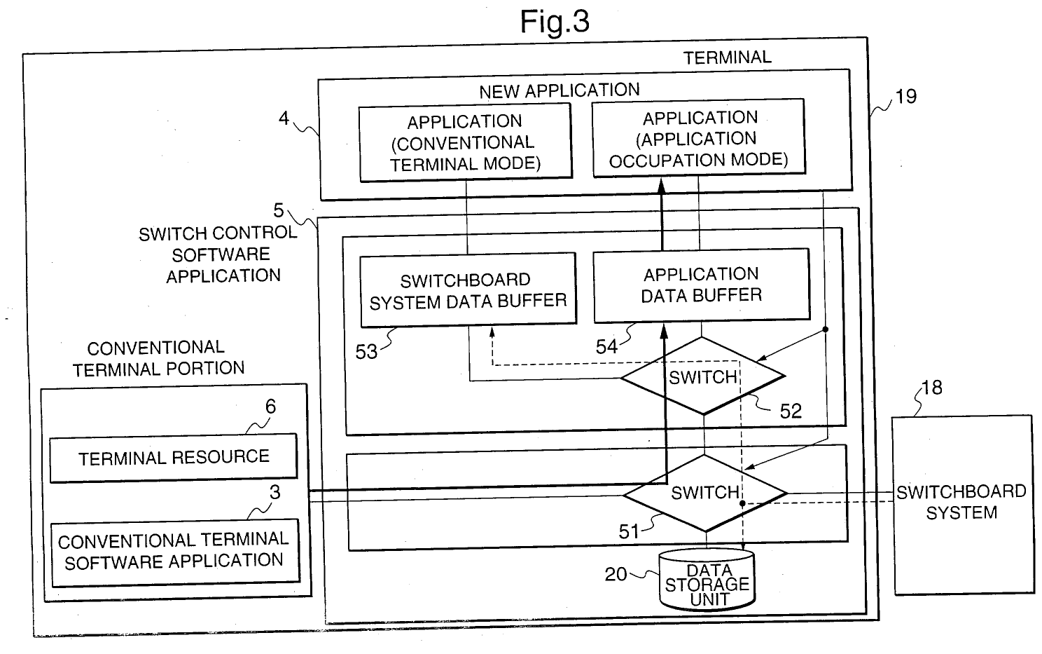

In FIG. 3 is shown an additional embodiment wherein the data exchanged by the conventional terminal software application 3 is processed when the application occupation mode is set. In this example, a data storage unit 20 is provided for sorting and managing data in accordance with the terminal display model types, so that when the application occupation mode is shifted to the conventional terminal mode by switching between the applications 4, the latest descending data, which is always transmitted to the switchboard system 18, is reflected to the terminal. The data storage unit 20 is a mechanism for holding data even in the application occupation mode. The latest data is also always transmitted to the switchboard system data buffer 53 of the switch control software 5.

In FIG. 3, when the conventional terminal resource 6 detects data, such as button depression data, a message is transmitted to the application 4 through the switches 51 and 52 and an application data buffer 54. And when data, such as the lamp ON data, is received from the switchboard system 18, this data is transmitted to the data storage unit 20 through the switch 51, and to the switchboard system buffer 53 through the switches 51 and 52.

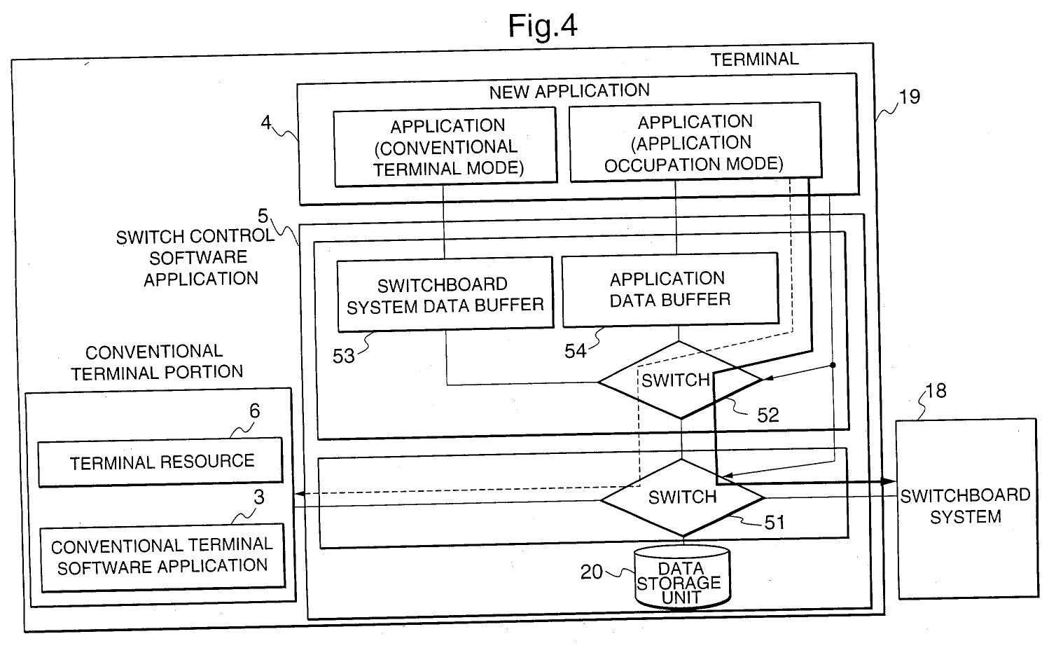

In FIG. 4 is shown a further embodiment wherein pseudo data issued by an application are processed when the application occupation mode is designated. The application 4 transmits pseudo ascending data, such as button depression data, to the switchboard system through the switches 52 and 51. Further, the application 4 transmits pseudo descending data, such as lamp ON data, to the conventional terminal software application 3.

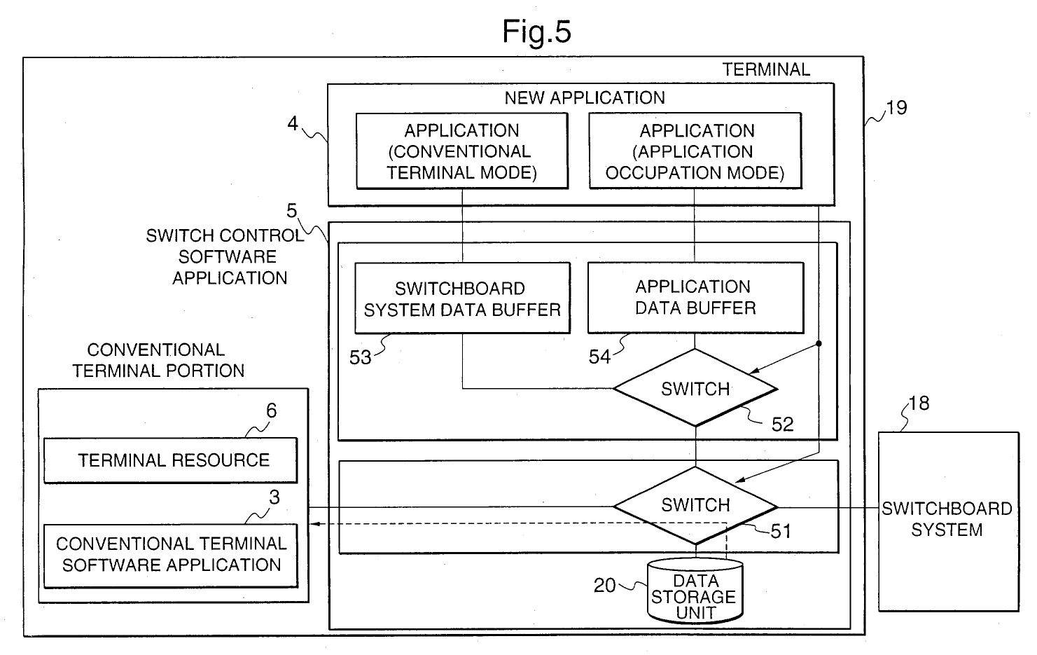

In FIG. 5 is shown a still further embodiment wherein the application occupation mode is shifted to the conventional terminal mode. In this configuration, the latest data stored in the data storage unit 20 in FIG. 3 is reflected to the conventional terminal portion when the mode is changed.

In the examples explained while referring to FIGS. 2 to 5, the switching between the switches 51 and 52 is performed by switching between the applications 4.

The above described embodiments are merely preferred examples for the present invention. The present invention is not limited to these embodiments, and can be variously modified without departing from the subject of the invention.

An additional software loading method for the invention can be implemented by permitting a computer to execute a program. This program is provided by being recorded on an optical recording medium, a magnetic recording medium, a magneto-optical recording medium or a semiconductor IC recording medium, or by being downloaded across a network using the protocol FTP (File Transfer Protocol) or HTTP (Hypertext Transfer Protocol).

As is apparent from the above explanation, according to the present invention, since a new application can be mounted by directly using the functions provided by conventional terminal software, an additional service can be provided only by developing a difference between the services. That is, functions provided by conventional software can be fetched without having to be regenerated and rebuilt by a new application, and the terminal control is enabled. Therefore, the number of required development procedures can be reduced, compared with when a new application is developed by installing the conventional terminal software.

As one decided advantage, especially when a telephone application is to be developed in a conventional terminal mode, a telephone service can be mounted without an application for the generation of software for basic telephone services being required.

While this invention has been described with reference to a certain preferred embodiment, it is to be understood that the subject matter encompassed by the invention is not limited to this specific embodiment. Instead it is intended for the subject matter of the invention to include all such alternatives, modifications and equivalents as can be included within the spirit and scope of the following claims.

What is claimed is:

1. A terminal device, which is operated by being connected across a network to a main apparatus that controls a terminal, comprising:
a first computer program for controlling a terminal resource;
a first CPU for executing said first software application;
a second computer program for executing a new application; and
a second CPU for executing said second software application,
wherein said second software includes a data relay unit for switching paths for an exchange of data among said first software application, said main apparatus and said new application, and
wherein said new application controls said data relay unit for switching between a conventional terminal mode and an application occupation mode.

2. A terminal device, as claimed in claim 1, wherein:
while in said conventional terminal mode, terminal status related data is transmitted by said first software application to said main apparatus, terminal control data is transmitted by said main apparatus to said first software application, data is exchanged between said first software application and said main apparatus, and said terminal status related data and said terminal control data are provided to the new application; and
while in said application occupation mode, said terminal status related data and said terminal control data are transmitted to said new application, and data received from said new application is transmitted to said main apparatus and said first software application.

3. A terminal device, as claimed in claim 2, wherein:
based on said terminal status related data that is received from said first software application through said data relay unit and said terminal control data that is received from said main apparatus, said new application redefines and regenerates pseudo terminal status related data and pseudo terminal control data; and
said new application transmits said pseudo terminal status related data and said pseudo terminal control data to said data relay unit.

4. A terminal device, as claimed in claim 1, further comprising:
an interface, provided between said new application and said data relay unit, that allows said data relay unit to employ control data received from said new application to switch between said conventional terminal mode and said application occupation mode.

5. A terminal device, as claimed in claim 2, further comprising:
an interface, provided between said new application and said data relay unit, that allows said data relay unit to employ control data received from said new application to switch between said conventional terminal mode and said application occupation mode.

6. A terminal device, as claimed in claim 3, further comprising:
an interface, provided between said new application and said data relay unit, that allows said data relay unit to employ control data received from said new application to switch between said conventional terminal mode and said application occupation mode.

7. A terminal device, as claimed in claim 1, wherein:
said data relay unit includes a data storage unit that classifies, while in said application occupation mode, said terminal control data for terminal display model types, and manages and stores said terminal control data received from said main apparatus; and
when said application occupation mode is changed to said conventional terminal mode, based on said control data received from said new application, data stored in said data storage unit is transmitted to said first software application and said new application.

8. A terminal device, as claimed in claim 2, wherein:
said data relay unit includes a data storage unit that classifies, while in said application occupation mode, said terminal control data for terminal display model types, and manages and stores said terminal control data received from said main apparatus; and
when said application occupation mode is changed to said conventional terminal mode, based on said control data received from said new application, data stored in said data storage unit is transmitted to said first software application and said new application.

9. A terminal device, as claimed in claim 3, wherein:
said data relay unit includes a data storage unit that classifies, while in said application occupation mode, said terminal control data for terminal display model types, and manages and stores said terminal control data received from said main apparatus; and
when said application occupation mode is changed to said conventional terminal mode, based on said control data received from said new application, data stored in said data storage unit is transmitted to said first software application and said new application.

10. A terminal device, as claimed in claim 4, wherein:
said data relay unit includes a data storage unit that classifies, while in said application occupation mode, said terminal control data for terminal display model types, and manages and stores said terminal control data received from said main apparatus; and
when said application occupation mode is changed to said conventional terminal mode, based on said control data received from said new application, data stored in said data storage unit is transmitted to said first software application and said new application.

11. A method for controlling a terminal device, which includes a first conventional software application that is executed by a first CPU to control a terminal resource and a second software application that is executed by a second CPU to execute a new application, and which is operated by being connected, across a network, to a main apparatus that provides control for said terminal device, comprising:
a switching step of permitting said new application to switch between a conventional terminal mode and an application occupation mode; and
a path switching step of changing, in accordance with said mode selected at said switching step, a path for data that is exchanged between said first software application, said main apparatus and said new application.

12. The method, as claimed in claim 11, wherein:
while in said conventional terminal mode, terminal status related data is transmitted by said first software application to said main apparatus, terminal control data is transmitted by said main apparatus to said first software application, and data is exchanged between said first software application and said main apparatus, and wherein said new application is notified of said terminal status related data and said terminal control data; and
while in said application occupation mode, said terminal status related data and said terminal control data are transmitted to said new application, and data received from said new application is transmitted to said main apparatus and said first software application.

13. The method, as claimed in claim 12, further comprising:
a regeneration step of permitting said new application, based on said terminal status related data received from said first software application and said terminal control data received from said main apparatus, to re-define and regenerate pseudo terminal status related data and pseudo terminal control data; and
a pseudo data transmission step of transmitting, to said main apparatus, said pseudo terminal status related data regenerated at said regeneration step and transmitting said pseudo terminal control data to said first software application.

14. The method, as claimed in claim 11, further comprising:
a data storage step of classifying, while in said application occupation mode, said terminal control data received from said main apparatus in accordance with terminal display model types, and managing and storing said terminal control data; and
a stored data transmission step of transmitting, when said application occupation mode is changed to said conventional terminal mode, said terminal control data stored at said data storage step to said first software application and said new application.

15. The method, as claimed in claim 12, further comprising:
a data storage step of classifying, while in said application occupation mode, said terminal control data received from said main apparatus in accordance with terminal display model types, and managing and storing said terminal control data; and
a stored data transmission step of transmitting, when said application occupation mode is changed to said conventional terminal mode, said terminal control data stored at said data storage step to said first software application and said new application.

16. The method, as claimed in claim 13, further comprising:
a data storage step of classifying, while in said application occupation mode, said terminal control data received from said main apparatus in accordance with terminal display model types, and managing and storing said terminal control data; and
a stored data transmission step of transmitting, when said application occupation mode is changed to said conventional terminal mode, said terminal control data stored at said data storage step to said first software application and said new application.

17. A medium containing a computer-readable program for controlling a terminal device, which includes a first conventional software application that is executed by a first CPU to control a terminal resource and a second software application that is employed by a second CPU to execute a new application and that is executed through a network connection to a main apparatus that controls a terminal, the computer-readable program comprising instructions to perform:
a switching process that switches between a conventional terminal mode and an application occupation mode; and
a path switching process that changes, in accordance with a mode selected during said switching process, a path for data that is exchanged by said first software application, said main apparatus and said new application.

18. The medium containing a computer-readable program, as claimed in claim 17, wherein the path switching process is arranged so that:
while in said conventional terminal mode, there is transmitted to said new application terminal status related data that is transmitted by said first software to said main apparatus, terminal control data that is transmitted by said main apparatus to said first software application, and data that is exchanged by said first software application and said main apparatus, and said new application is notified of said terminal status related data and said terminal control data; and
while in said application occupation mode, said terminal status related data and said terminal control data is transmitted to said new application, and data received from said new application is transmitted to said main apparatus and said first software application.

19. The medium containing a computer-readable program, as claimed in claim 18, further comprising instructions to perform:
a regeneration process that redefines and regenerates, based on said terminal status related data received from said first software and said terminal control data received from said main apparatus, pseudo terminal status related data and pseudo terminal control data; and
a pseudo data transmission process that transmits to said main apparatus said pseudo terminal status related data regenerated during said regeneration process, and that transmits said pseudo terminal control data to said first software application.

20. The medium containing a computer-readable program, as claimed in claim 17, further comprising steps to perform:
a data storage process that, in said application occupation mode, classifies said terminal control data received from said main apparatus in accordance with terminal display model types, and manages and stores said terminal control data; and
a stored data transmission process that transmits, when said application occupation mode is changed to said conventional terminal mode, said terminal control data stored in said data storage process to said first software application and said new application.

21. The medium containing a computer-readable program, as claimed in claim 18, further comprising steps to perform:
a data storage process that, in said application occupation mode, classifies said terminal control data received from said main apparatus in accordance with terminal display model types, and manages and stores said terminal control data; and
a stored data transmission process that transmits, when said application occupation mode is changed to said conventional terminal mode, said terminal control data stored in said data storage process to said first software application and said new application.

22. The medium containing a computer-readable program, as claimed in claim 19, further comprising steps to perform:
a data storage process that, in said application occupation mode, classifies said terminal control data received from said main apparatus in accordance with terminal display model types, and manages and stores said terminal control data; and
a stored data transmission process that transmits, when said application occupation mode is changed to said conventional terminal mode, said terminal control data stored in said data storage process to said first software application and said new application.
